(19) United States
(12) Patent Application Publication
(10) Pub. No.: US 2014/0297390 A1
(43) Pub. Date: Oct. 2, 2014

(54) METHOD OF SECURE COMPENSATION OF GROUPED PROMOTIONAL SALES WITH VARIABLE RATE AND SYSTEM FOR IMPLEMENTING SAME

(71) Applicant: Pierre Grindel, Le Grand Pressigny (FR)

(72) Inventor: Pierre Grindel, Le Grand Pressigny (FR)

(73) Assignee: 55 INTERACTIVE, Paris Cedex (FR)

(21) Appl. No.: 14/129,857

(22) PCT Filed: Jun. 29, 2012
(86) PCT No.: PCT/EP2012/062730

§ 371 Date: Apr. 15, 2014

(30) Foreign Application Priority Data
Jun. 29, 2011 (FR) 1155838

(51) Int. Cl. G06Q 30/02

(52) U.S. Cl. CPC G06Q 30/0238; G06Q 30/0236
USPC 705/14.36; 705/14.38

(57) ABSTRACT

A purchaser user enrolled with a service provider for promotional sales is provided with a smart cell phone and possibly a bank card issued by a banking partner of the service provider, said bank card being associated with a debit/credit account for a means of payment for promotional sales of the service provider. After having been grouped together the purchasers make their purchases within the framework of a grouped promotional sale using purchase coupons issued by the service provider to the cell phone of each purchaser user. Said user pays for his or her purchase while benefiting from a first discount. The service provider reconciles the cash register receipts and the purchase coupons, calculates a second reduction as a function of the validated purchases of the members of each purchase group and credits, if appropriate, the members of each group with said second reduction.

### FIELD OF THE INVENTION

The present invention belongs to the field of computer systems for managing consumer sales. More specifically, it makes it possible to offer the public promotional sales in reliable safety conditions for the commercial and banking brand names putting such sales in place. The invention therefore relates to a “clearing” method, otherwise referred to as “compensation” elsewhere in this application.

### BACKGROUND

The expansion of the Internet has paved the way for a significant growth in targeted promotional sales. For example, a site can offer its enrolled members a local selection of promotions which enable small traders to benefit from a marketing tool targeted on their area of attraction.

In the case of Groupon (registered trademark, http://www.groupon.com), the enrolled member who chooses a given offer is sent a coupon by email that he or she pays for immediately by debiting his or her account and which he or she then uses to acquire the good or service purchased from the trader or service provider. The price that is the object of the promotion may be subject to a condition of reaching a quota. The member can benefit from advantages in the form of additional reduction vouchers if other members that he or she sponsors make purchases.

Such systems lack flexibility, notably by not allowing the promotion rate and/or its amount to vary during the period for which it is open, the coupon having a fixed value.

However, there are not as yet any systems for managing promotional sales with variable rates, notably based on the number of purchasers during the promotion period, the problem posed by centralizing the transactions in a sufficiently reliable manner to allow for the final calculation of the discount rate not having been resolved by the systems of the prior art.

### SUMMARY OF THE INVENTION

It is therefore the object of the present invention to resolve this problem.

To this end, the invention discloses a computerized method for managing grouped promotional sales comprising at least one step of registering a purchaser user with at least one grouped promotional sale by connection to a service provider using a user terminal, a step of determining a first discount applicable to said at least one promotional sale, a step of purchase by said purchaser user at a point of sale at the price resulting from the application of said first discount, said method being characterized in that it also comprises a step of validation by said service provider of the purchases made by the purchaser users that are members of the group enrolled with said grouped promotional sale at the date of closure of said grouped promotional sale and a step of calculating a second discount that is a function of the amount of the validated purchases.

The invention also discloses a computerized method for managing the clients of a distribution network comprising at least one step of registration of said clients and at least one step of purchase from a store of said network, said method being characterized in that said registration step comprises at least one substep of enrollment with said distribution network during which said client supplies information relating to his or her identification enabling him or her to download, to a cell phone, at least one computer application that can be executed on said cell phone and in that the purchase step comprises at least one first substep of downloading a purchase coupon issued by the network to said at least one cell phone, said purchase coupon comprising an identifier of said client for this purchase, and a second substep of transferring said identifier between the cell phone of said client and a cash register receipt of a point of sale of said network.

The invention also discloses a computer system for managing grouped promotional sales comprising at least one module for registering a purchaser user with at least one grouped promotional sale by connection to a service provider using a user terminal, a module for determining a first discount applicable to said at least one promotional sale, a module for payment for a purchase by said purchaser user at a point of sale at the price resulting from the application of said first discount, said system being characterized in that it also comprises a module for validation, by said service provider, of the purchases made by the purchaser users that are members of the group of said grouped promotional sale at the date of closure of said grouped promotional sale and the module for calculating a second discount that is a function of the amount of the validated purchases.

The method of the invention can easily be implemented in conjunction with smart phone terminals which now offer powerful geolocation capabilities and therefore the capabilities to disseminate promotional offers that are highly targeted geographically.

The method of the invention is particularly suited to the promotional sales applicable to everyday objects such as clothes, footwear, computer, audio or video appliances, DIY and domestic electrical equipment. It allows for the management of promotional offers that are simultaneously applicable to remote purchases on a website and to purchases in physical points of sale.

It is also advantageous to use the system of the invention in combination with a prepaid payment card, debiting a current account or containing electronic money.

In particular embodiments of the invention, the method of the invention exploits the application of the service present on the smart phone of the member and the cash register management system of the points of sale to simply perform the production and the collection of all the reasonably necessary information (a pseudo-unique identifier or a unique code) to ensure the reliability of the purchase validation method which makes it possible to benefit from particular advantages, for example from a second discount whose amount has to be determined safely, or from aggregating loyalty points, or even from a first discount.

### BRIEF DESCRIPTION OF THE DRAWINGS

The invention will be better understood and its advantages will emerge even more obviously on studying the attached figures which represent embodiments of the present invention.

FIG. 1 represents a functional architecture diagram of a method for implementing the system of the invention.

FIG. 2 represents a technical architecture diagram of a system according to the invention.

FIG. 3 represents a step prior to the sale in one embodiment of the system of the invention.

FIG. 4 represents a first embodiment of a purchase step in one embodiment of the system of the invention.

FIG. 5 represents a second embodiment of a purchase step in one embodiment of the system of the invention.

FIG. 6 represents a detail of issuing of a purchase coupon in the sale step according to one embodiment of the system of the invention.

FIGS. 7, 8 and 9 represent three variants of a post-sale reconciliation step according to one embodiment of the system of the invention.

FIG. 10 represents a deferred discount processing step according to one embodiment of the system of the invention.

FIGS. 11a, 11b and 11c represent a device making it possible to assign the identity of a purchaser to a cash register receipt according to one embodiment of the system of the invention.

FIGS. 12a, 12b and 12c represent details of the steps of issuing of a purchase coupon and of the use of an associated code in the sale step according to a number of variants of the system of the invention.

FIGS. 13a and 13b show the progress of a step of reconciliation of cash register receipts and coupons in the variants of the system of the invention illustrated in FIGS. 12a, 12b and 12c.

FIG. 14 represents details of steps of issuing of a purchase coupon and of use of an associated pseudo-unique or unique code in the sale step according to several variants of the invention.

### DETAILED DESCRIPTION OF CERTAIN EMBODIMENTS

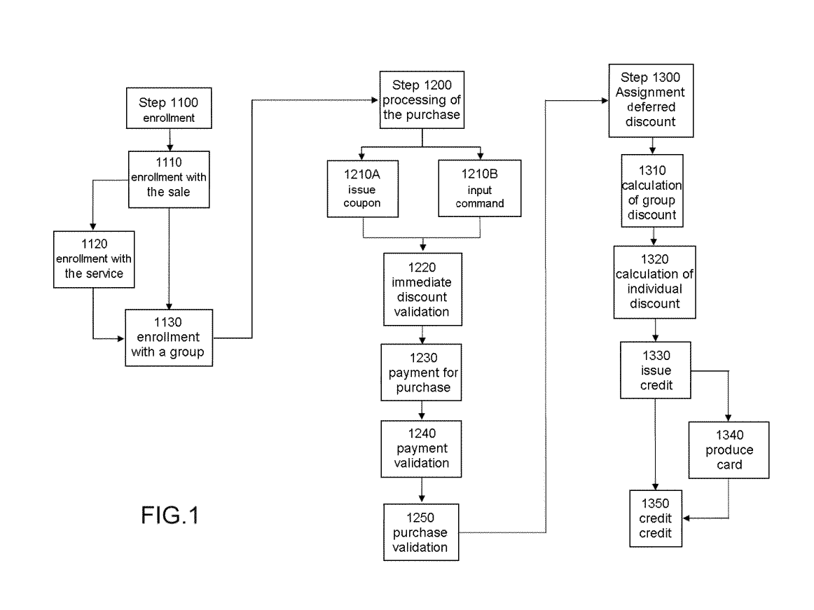

FIG. 1 represents a functional architecture diagram of a method for implementing the system of the invention.

In a service proposed by a system implemented according to the invention, a multi-channel grouped flash sale (VFG) service is proposed on behalf of brand names, manufacturers or independent traders.

Hereinafter in the application, the terms “grouped flash sale”, “flash sale” or “grouped promotional sale” will be used without distinction to denote the concept of grouped flash sale (VFG),

A grouped flash sale is defined as a promotional operation of limited duration proposed:
by a partner in physical points of sale and/or on the Internet
to the members who are previously grouped together.

Said sale relates to a purchase of a minimum value, the amount of the reduction depending on the number and/or the value of the purchases made by the members of one and the same group.

According to one embodiment of the invention, a VFG can be implemented as described below.

Some days before the start of the VFG, the members of the service are informed of its features (start date, duration, maximum reduction amount, as a percentage or as a value; for each level, expressed as a number of purchasers, the amount of the additional reduction is provided, expressed as a percentage or as a value; minimum amount for a purchase of the products or services that are the object of the promotion).

The members are invited to participate in the sale by forming a group of purchasers, or by being incorporated in a group of purchasers. It is the number of purchasers having made a purchase in a group which will determine the level of the final discount for all the members of this group. In order to strengthen the attractiveness of the operation, a first part of the reduction (for example half) is granted upon payment for the purchase in the form of a discount: the member is thus certain to obtain a minimum advantage. This first reduction may be immediate or deferred until the purchase is validated by the service. It is therefore the second part of the reduction which is linked to the number of purchasers. To remain attractive, the maximum number of purchases to be reached is low (for example between 3 and 5): a purchase made by a member of a group enables each purchaser of this group to reach an additional discount level.

Thus, after the purchases have been validated, the level reached by each group is definitively established. The amount of the discount is established for each purchase and is finally paid back to each member.

The principle can be made available in a number of solutions to be applied to all the trade sectors of interest for the potential users.

In the fields of catering (fast food included), the hotel trade, wellbeing (spa, gymnasia, etc.), events (theatre, concerts, cinema), the members will be able to make voucher acquisitions. These vouchers will enable the members to benefit from the service defined in the specific pricing conditions of the service. Being sold directly and exclusively by the service, all the information will be managed in full by the service to assign the immediate or deferred discounts to each purchaser, according to the principles described above.

This solution offers the advantage of avoiding a possible failure of the merchant before the payment of the additional discount: it is therefore particularly suited to small structures. The process implemented to manage these vouchers is similar to those followed by the sites such as Groupon, and falls within the state of the art.

In the fields of clothing, footwear, computing, image and sound, DIY and domestic electrical equipment, the grouped flash sales will be able to be deployed equally with merchants having only an electronic sales network, or having a mixed marketing infrastructure, comprising a web site and a network of physical points of sale.

In the case of a partner having only a web site, the use of a service email address and tracked links ensure the traceability by the service of all the exchanges between the member and the merchant site. The process is then similar to those followed by the cashback sites.

The method making it possible to implement and manage a grouped flash sale according to the present invention applies to all the partner brand names having a network of points of sale and possibly a merchant web site.

As indicated in FIG. 1, the method can be broken down into three main phases:
before the sale (step 1100), the members must be informed of the launch and of the conditions of the sale, be enrolled with said sale and invite their “friends” to participate in said sale; if appropriate, the non-members, informed of the launch of the sale by their “friends”, must be able to be enrolled with the sale itself and with the service;
during the purchase (step 1200), the processing will be different depending on whether the purchase is made online (electronic order and payment) or at a physical point of sale; for the latter modality, a coupon must be handed over to the member participating in the sale; the process of the invention must then process the validation of the purchase with assignment of a first discount, the validation of the payments, which will then be used to aggregate the validated purchases by the members of the group of friends, and calculate a second discount after the closure of the sale; the modalities for validating the purchase made and its eligibility for triggering a second discount are determined; the validation modalities will depend on the type of sales channel used (by Internet or in points of sale), on the payment means used by the member (paper money or bank money, payment card, payment card having the service embedded), and the means of communication of the points of sale with a possible network termination;
after the purchase (step 1300), the validations of the step 1200 are used to determine the rate of the second discount applicable to the group, then to each of the members of the group; finally, the manner in which the discount is paid cash register has to be determined; in the case where the member of the service has a payment card with service embedded, the preferred method for paying back the discount acquired is to credit said payment card; in the particular case where the member has just joined and where the launch of the production of his or her card has not yet been triggered, it is possible to launch said production on completion of the first VFG if the second discount applicable according to the terms and conditions of said sale is an amount greater than or equal to the sale price of said card by the service; the balance of the net discount on the price of the card is then credited to the account of the member.

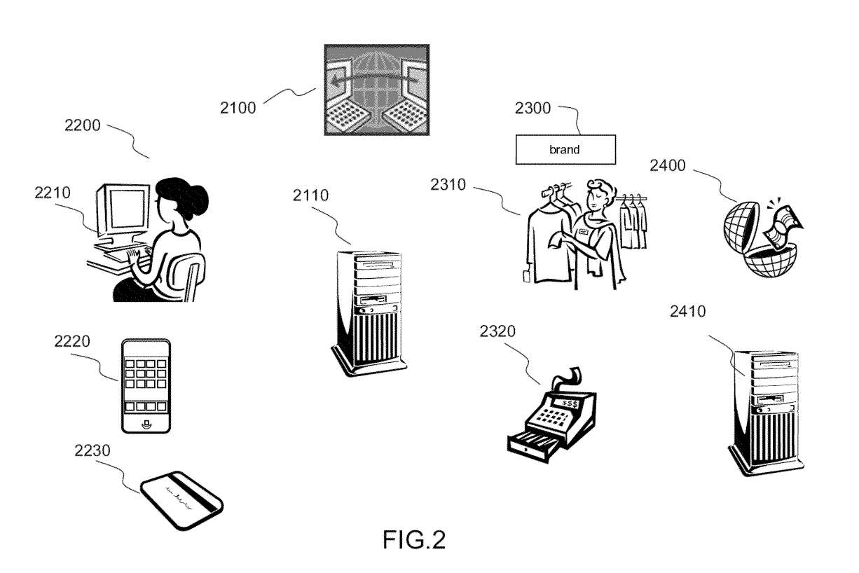

FIG. 2 represents a technical architecture diagram of a system according to the invention.

The grouped flash sales service, 2100, has to have servers connected to the Internet network enabling it to be in communication with its members, 2200, its partner brand names, 2300, and, where appropriate, its banks, bank card services or partner financial services, 2400.

The service manages databases stored on mass memories, 2110.

A first database contains the data relating to the members, on the one hand the enrolled members, on the other hand the members currently enrolling. The prospects can also be managed. Certain identification data (civility, first name, domicile) are essential; others can be useful (payment means, general conditions of sale (CGV) and general conditions of use of the service to which he or she has subscribed, smart phone number, without this list being mandatory or limiting). The database also includes, for each member, the data relating to the current VFG in which he or she is participating (possibly several in parallel) and notably the general conditions of sale specific to each grouped flash sale (VFG). The historic data on the participation of the member in preceding VFGs make it possible to target the promotions more relevantly and to direct the information on subsequent sales more effectively. For each of the members, it is also possible to keep in memory the reference of the “friends” that he or she has invited to participate in prior sales and of those who have accepted this invitation, linked to the object of the sale.

A second database contains the data relating to the partner brand names and their marketing establishments (location of stores, purchase validation modalities, agreement, etc.).

It may be necessary to have a third database containing the data relating to the banking, financial or partner card services (payment validation conditions, conditions applicable to the cards, etc.).

A user, current or potential, of the service, 2200, may normally have a terminal, 2210, a smart phone, 2220, payment means, 2230. A user who is not yet a member, not having all the above items, will be able to participate in a VFG only if he or she is the holder of a smart phone; he or she will have been able to be informed by an SMS or a notification received on his or her smart phone, make his or her purchases in a point of sale of a partner brand name, pay for his or her purchases by any payment means. He or she will be able to benefit from the grouped flash sale discount to acquire the card of the service (see below); save any marketing act on the part of the bank or the brand name, the subsequent advantages will be able to be conditional on the use of the service card.

If he or she has a terminal, 2210, the member of the service will be able to make his or her purchases on the web sites of the partner brand names. If he or she has a smart phone provided with geolocation functionalities, 2220, he or she will be able to be informed in real time of the location of the stores of the partner brand names in his or her near environment with a visual indication of current grouped flash sales to which he or she has subscribed or to which he or she has been invited by his or her “friends”. The smart phone also makes it possible to easily print out a single-use first reduction coupon which can be produced at the cash register of a point of sale of the partner brand name. The smart phone therefore has a complete grouped flash sales application supplied by the manager of the service. The latter, in partnership with a bank, will be able to choose to issue a VFG service card, 2230, constituting a rechargeable payment means. In practice, as will be seen later, this embodiment increases the overall effectiveness and the operational security of the service. It also provides the partners of the service with a marketing tool which is itself effective.

The partner brand names, 2300, will, as a general rule, have an electronic store and physical stores, 2310. The payments from the members or non-members made by bank card are normally validated by a terminal, 2320, in which the user enters a PIN code. The validation is done in real time, by connecting the terminal to the bank card authorization center. The centralization of the data that makes it possible to reconcile transactions made in physical points of sale with the payments normally takes place once a day via the management application of the partner brand name.

One or more partner or non-partner banks, 2400, validate, on the one hand, the payments made in the partner brand names by a client who uses a card, 2230, distributed by their network. The card can be of several types:
conventional bank card, assigned to a deposit or savings bank account, with its holder having joined the VFG service;
prepaid bank card, which may or may not be rechargeable: the card is not assigned to a bank account, but to an account specific to the card; the card can be used for any payment within the limit of its instantaneous balance, checked on each transaction; any recharging is done by transfer from a bank account, said transfer being able to be made by a simple transaction in an automated teller machine, or by any other modality defined by the network which distributes it (in the case in point, the partner bank of the VFG service credits the card with the amount of the additional discounts acquired after validation of the VFG);
electronic money card, which includes an area in which the available amount is stored in a memory area of the card.

In all these cases, which constitute embodiments of the invention, it will then be said that the service is “embedded” on the card.

The launch of rechargeable prepaid cards is a recent development and seems to be exciting keen interest. It is probable that this modality will be preferred by the banks which will thus be able to develop a new clientele inexpensively. The expansion of the use of electronic money cards remains restricted within a tight regulatory framework and its expansion does not seem very promising.

In the preferred embodiments of the invention, described above, the VFG service is therefore “embedded” on the payment card, 2230, for which the issuing bank holds the account on one of its servers 2410: top-ups made by the member; credit for discounts acquired during VFGs; payments made; thus, the balance of the member's card is incremented on each VFG for which the member has obtained a second discount and decremented on each purchase for which the partner bank authorizes the debit on the card. A bank may be able to derive an advantage in ensuring the promotion of a VFG service in as much as, on the one hand, the card supplying service may in itself be profitable and the bank can take indirect benefits therefrom through the attractiveness created for other services that it provides and thus significantly broaden its client base.

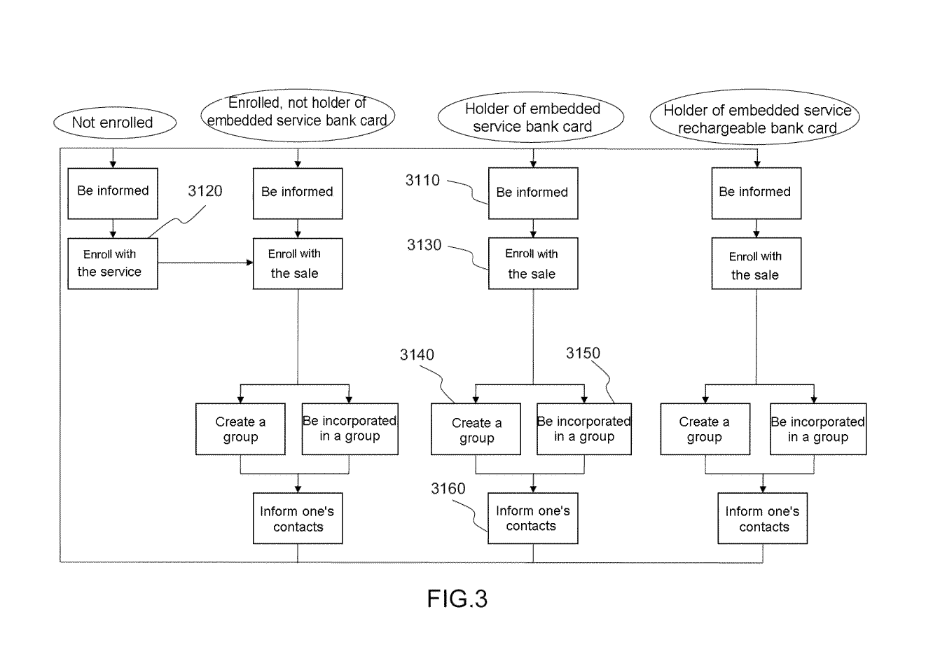

FIG. 3 represents a step prior to the sale in one embodiment of the system of the invention.

A first step of the grouped flash sales method according to the invention is a step, 3110, of informing of the existence and conditions of said sale.

The members and non-members of the service are informed of a VFG by:
messages sent by the service (service email sent to the subscribers to the newsletter; communication campaign via web and mobile-email, banner, animation, etc.);
messages relayed by the members and non-members inviting to participate in a sale or to enroll in the service.
   The enrollment in the service, 3120, is possible via the Internet or smart phone, after the application has been downloaded. The necessary information is:
email, password, possibly pseudonym;
and acceptance of the general conditions of use and of sale of the service.

The enrollment via the Internet is validated, for example, after the sending of a confirmation email by the activation service of the enrollment link, this step not being a priori necessary for the users provided with a smart phone whose identification is confirmed by their call number (or the assignment of a unique service identifier at the time of the loading of the application).

In the case where the use of the service is conditioned by the use of a payment means, the users can subscribe to different service modalities depending on the type of payment means that they want to use.

Depending on the subscription modalities, the documents to be supplied to be enrolled and the enrollment modalities may differ, some banks being able to impose special formalities to issue their cards, even impose face-to-face personalization.

To be enrolled in a given VFG, step 3130, it is then sufficient to be identified on the site of the service or on the mobile application, then to declare the intention to participate in the sale. It may be necessary to provide a specific validation of the general conditions of each VFG.

If the sale is based on the loyalty card of the partner, it may be necessary to enter the loyalty card number. This will make it possible to simplify the reconciliation between the cash register receipt and the claimed purchase, as will be explained later in the description.

One of the functionalities offered by one of the embodiments of the system according to the invention is to enable a member to meet up with purchase groups.

A first modality for doing this is to create a purchase group: the member creates a group by creating a distribution list through the creation, importing or pushing of email addresses, of lists of friends or contacts (email tool, facebook or Twitter, etc.).

A second modality is incorporation in an existing purchase group:
the prospect has received a message (email, SMS, or other alert, etc.) from a sponsor inviting him or her to enroll in the VFG;
he or she activates his or her participation in the VFG and validates his or her incorporation in the group of his or her sponsor;
he or she is invited to push the information in his or her own network;
each time a new member is incorporated in a purchase group, each can be informed of the incorporation, of the new discount level potentially reached and of the minimum amount potentially paid back (calculated according to the minimum amount per purchase).

It will be noted that a person who receives an invitation from a sponsor to participate in a VFG can create his or her own group. It is, if necessary, possible to disengage from a group in order to enter into another group, either until the purchase or until the closure of the sale.

After the creation of a group (or an incorporation in a group), the member sends his or her contacts an invitation to participate in the sale.

It is possible to participate in several VFGs and therefore in several groups in parallel.

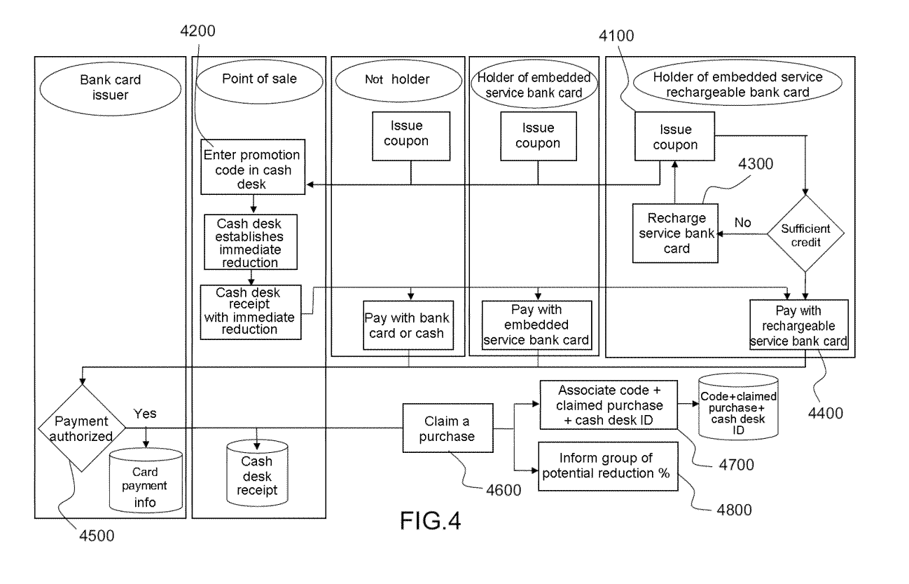

FIG. 4 represents a first embodiment of a purchase step in one embodiment of the system of the invention.

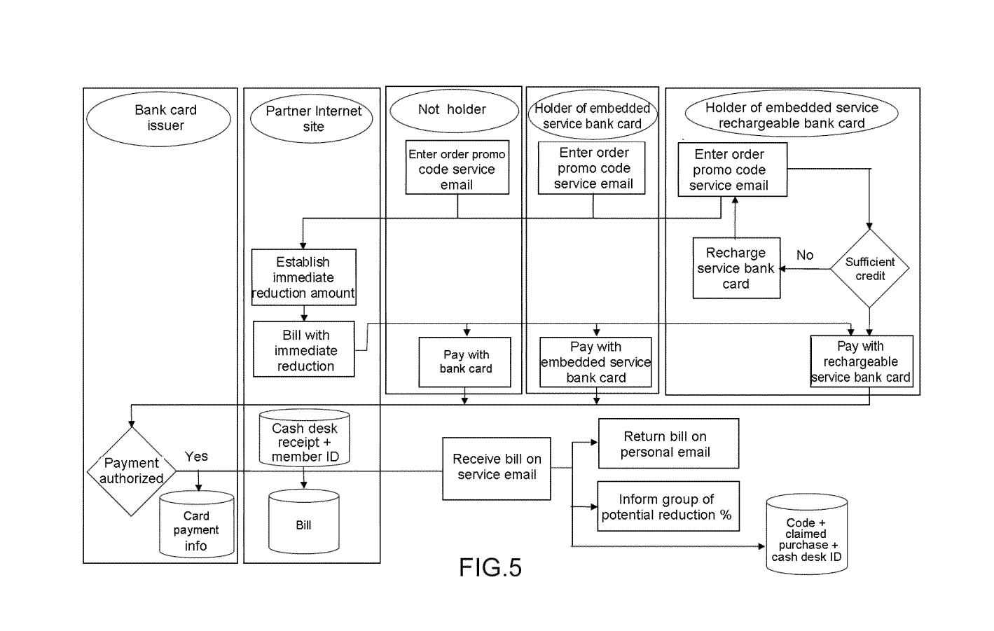

FIG. 5 represents a second embodiment of a purchase step in one embodiment of the system of the invention.

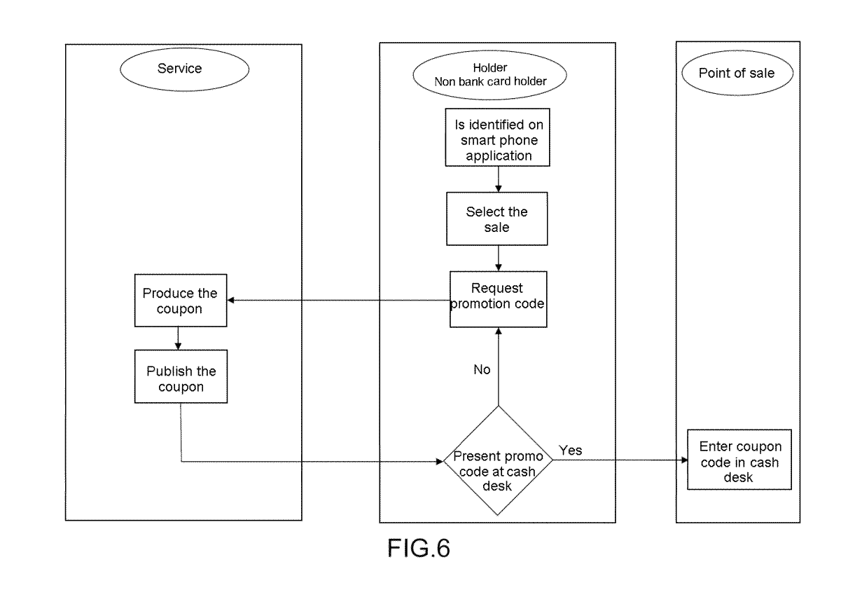

FIG. 6 represents a detail of the issuing of a purchase coupon in the sale step according to one embodiment of the system of the invention.

FIG. 4 and FIG. 5 respectively represent the performance of the purchase step in a physical point of sale and on the Internet, it being understood that, for one and the same VFG, the sales at points of sale and the sales on the Internet can coexist.

When the purchase takes place in a point of sale, the first step, 4100, of the VFG process is the issuing of a coupon by the service managing the grouped flash promotion. The purchase coupon can be an electronic or intangible coupon, consisting of an image on the screen of the member's smart phone.

In this embodiment, to benefit from the immediate discount, the member must, when at the cash register of the point of sale, as represented in FIG. 4 and in more detail in FIG. 6:
activate the application on his or her smart phone;
be identified;
select the VFG;
request the promotional code, date- and time-stamped for example at the time of its production which, once entered in the cash register system, will make it possible to establish the amount of the first part of the reduction;
the time for which a coupon is displayed is limited (10 seconds for example). It corresponds to the time needed to present it to the vendor. Once this time has expired, the member must, if necessary, request the display of a new promotional code.

The duly displayed promotional code is picked up by the vendor in the cash register system (step 4200). It reprises the information described in the VFG: brand name, offer, point of sale and issue date. It makes it possible:
to calculate and apply the immediate reduction in the cash register system if there is one;
to partly ensure the traceability of the cash register receipt (by being included in the receipt).

Certain applications that can be integrated in the VFG application allow for the display of a barcode or of a “coded visual” on the screen of the smart phone and for it to be read by the scanner of the cash register.

In the case illustrated by FIG. 5 of a purchase by a member on the Internet, the member must enter the promotional code and, where appropriate, his or her service email in the site's order form in order to benefit from the advantage of being registered as having participated in the VFG and of thus being able to contribute to reaching the objectives set for the second reduction to be assigned.

To return to the case of a sale at a point of sale, different payment modalities can be envisaged, depending on the type of payment means associated or not with the service that the member will use.

If the member has a bank card in which the service is embedded with a rechargeable amount, the first step must be to test that the amount available on the card is sufficient and, if not, to ask the user to perform a recharge, during a step 4300. The user enters the amount to be paid. If the amount available is less, the system prompts him or her to recharge his or her card by an amount at least equal to the value of the difference between the amount of the purchase and that available. He or she may also recharge his or her card in an ATM of the partner bank.

In order to render the use of the service more fluid, a variant of the “PayPal”™ type can be implemented:
The card of the service is associated with the member's bank card;
At the time of payment, the authorization request is made on the card of the service but then generates a second authorization request, to the banking establishment issuing the associated card.

In this variant, the amount of the authorization request may take into account the balance of the card of the service issued. It is important to be aware of the fact that, in this case, the purchase could be considered as a remote purchase: in order to avoid its rejection (and therefore the acceptance of responsibility for the equivalent amount as compensation for the merchant), the user will, for example, have to enter, for each transaction, a secure 3D code (random code of eight digits issued by his or her bank, of one-time use and sent by SMS to his or her smart phone).

Once the recharging has been done, the payment is made during a step 4400 then validated by the banking establishment during a step 4500.

In the absence of a rechargeable card, the member will at least have to be the holder of a bank card with the service embedded (eligible card issued by the partner bank or prepaid bank card). In order to benefit from the deferred discount, the member must pay with a bank card having the service embedded. If the purchase is authorized by the bank, the deferred discount will be able to be paid back.

However, a member who does not yet have a bank card with the service embedded, or whose card is expired or not yet issued, can participate in a VFG by paying in cash or with a bank card which does not have the service embedded.

A priori, the cheque payment method is excluded from the main embodiments of the invention, because it can generate a dishonored payment and therefore an overestimation of the deferred discount level reached by the purchase group to which it refers.

According to the invention, once the payment is made, the member must claim his or her purchase act, during a step 4600 in order:
To increase the reliability of the assignment of the identity of a member to each cash register receipt, by checking the presence of the member at that point of sale, and the identification of the cash register at which he or she has made his or her purchase;
To then inform the other members of his or her purchase group of the new deferred discount threshold potentially reached.

Several variants are possible to enable the member to claim the purchase that he or she has made.

A first modality for claiming the purchase is to ensure an identification of the cash register of the point of sale. Thus, by virtue of the application embedded on the smart phone, the member must pick up an image which makes it possible to uniquely identify the cash register and the point of sale. This image can be a 2D code or a barcode, which is present on the cash register, or on a printed card present at the cash register. This visual identifier is presented by the vendor or can be photographed without the vendor's intervention. The application validates the quality of the image, then transmits it to the servers of the service.

When the member does not have a bank card embedding the service, and the preceding purchase claim refers to a member who does not have a bank card embedding the service, it is necessary to collect an additional proof of purchase, for example by means of entering the number of the cash register receipt, the amount of the transaction or another characteristic information item in the smart phone application.

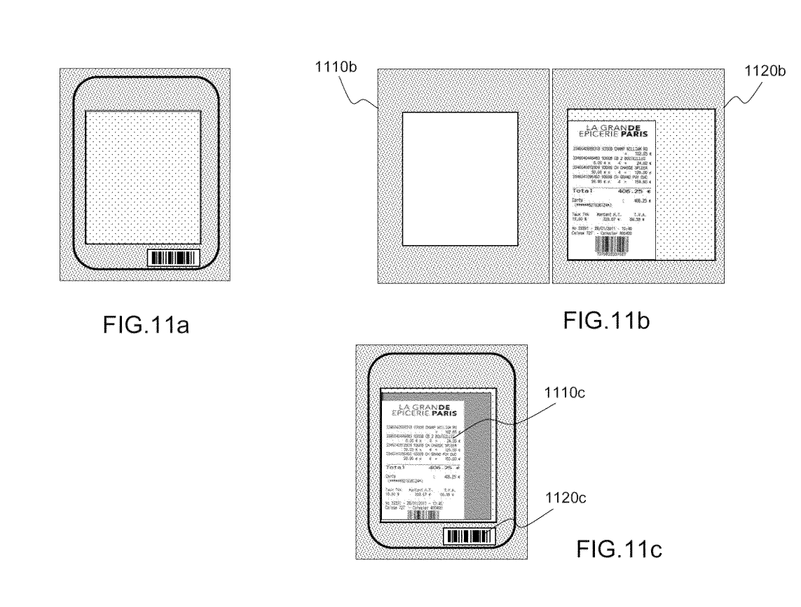

A second modality for claiming the purchase consists in performing a capture of the image of the cash register receipt as explained later in the description in the commentary to FIGS. 11a, 11b and 11c.

A third modality for claiming the purchase by the member can be implemented if the point of sale is equipped for contactless payment with transmission of the cash register receipt directly between the TPE (payment terminal) and the smart phone. The applications of the NFC (Near Field Communication) technology are promising and burgeoning for payments, for the time being primarily in the transport field, but deployment in points of sale should follow. When the hardware and application environment permits (TPE and smart phone both equipped; suitable application on the smart phone), it is therefore possible to unambiguously associate the date- and time-stamped coupon on the smart phone and the cash register receipt including the cash register code and the promotion code, justifying the purchase made against the coupon.

In all cases, the member makes the claim for the purchase to the manager of the service who must perform the validation of this purchase claim during a step 4700. A purchase is considered to be validly claimed only on condition that the reduction coupon is issued and the collection of the information at the point of sale has been successful (point of sale, cash register identifier and possibly cash register receipt number). Without this full information, the purchase will not be able to be validated and the second discount will not be paid back.

In the case of a purchase on the Internet (FIG. 5), the order confirmation and the bill are sent by the merchant site to the service email of the member, which then associates them with the email of the member to forward to him or her. This process thus makes it possible to obtain an implicit purchase claim.

After claiming a purchase, each member of the purchase group is informed, during a step 4800, of the claimed purchase and (possibly) of the identity of the purchaser (who may be identified by his or her pseudonym), of the new discount level potentially reached (this information will become definitive only when all the purchases of the group have been validated).

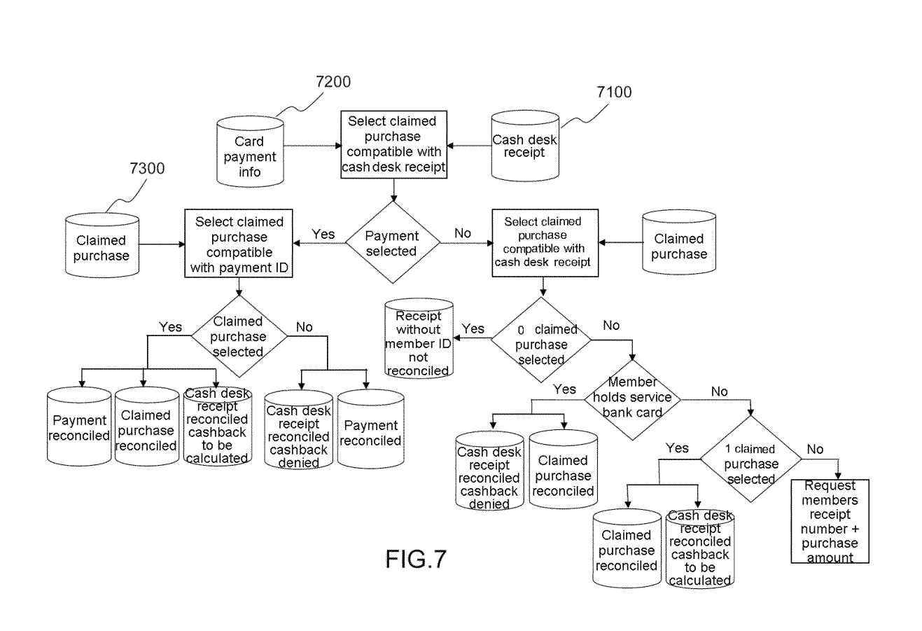

FIGS. 7, 8 and 9 represent three variants of a post-sale reconciliation step according to one embodiment of the system of the invention.

After the sale, the partner brand name transmits to the manager of the service all the cash register receipts including a promotional code. The cash register receipts are sorted, for example, by point of sale and cash register, on the criterion of date in ascending order. It is thus possible to then check the correct use of the service; has the member:
claimed his or her purchase
and paid with the bank card embedding the service, if he or she has one.

After these checks, it is possible to:
calculate the deferred discount percentage reached by each purchase group;
calculate the amount of the deferred discount for each member of each purchase group;
produce and issue the corresponding credit;
pay back this sum to the card of the member if he or she has one, or to a pending account;
and possibly issue the card to the members who do not yet have one.

Two variant embodiments are retained for checking the correct use of the service.

In a first variant embodiment:
For the members provided with a bank card embedding the service, a check is carried out to ensure that they have paid for the purchase therewith, then that they have claimed their purchase;
For the members without a bank card embedding the service, a check is carried out to see if they have claimed their purchase.

To increase the reliability of the clearing of the purchase claims, it is possible to perform a reconciliation of the cash register receipts with the identity of the members having made them with a bank card embedding the service. Thus, it will be possible to reconcile the cash register receipts with the payments.

The modalities for reconciliation between receipt, payment then claimed purchase are detailed below.

The process starts with a first database, 7100, of the cash register receipts, a second database, 7200, of the payments with cards with embedded service and a third database, 7300, of the claimed purchases.

The first processing operation consists in finding the payment corresponding to the cash register receipt. For each cash register receipt:
Searching for the corresponding payment, for example, on the following criteria: member identifier (if the information is present on the receipt and if it was collected by the service before the purchase), point of sale of the partner brand name, time of the transaction, amount and possibly cash register and payment number (authorization number and/or truncated card number);
Checking the consistency of the time bands according to predefined criteria, for example: the date of the payment must be less by less than a minute than that shown on the receipt (it will be noted that it is advantageous to provide thresholds that are variable according to the crowd in the points of sale, and therefore according to the places and times of purchase).

If a payment is selected, it is then essential to check that the identified member, holder of the bank card, has claimed his or her purchase at the same point of sale in a consistent time band:
Searching for the corresponding claimed purchase, for example on the following criteria: member identifier, point of sale, cash register identifier, receipt date (day, minute, second);
Checking the consistency of the time bands:
   Was the coupon associated with the claimed purchase issued before the date of issue of the cash register receipt?
   Is the purchase claim date consistent? For example, does it lie within a quarter hour interval after that of the coupon?

The following processing operations are then, by way of example, applied, in the case where a payment exists in the payments base, 7200:
No claimed purchase is found in the claimed purchases base, 7300; the procedure has not been observed, but the manager service may decide to make a marketing gesture because the member has indeed made a purchase using the bank card of the service:
If the member is attached to a purchase group, the manger service will be able to take his or her purchase into account when accounting for the purchases actually made by the members of this purchase group;
The manager service will alternatively be able to assign to the member concerned the threshold corresponding to that of a purchase in the group;
A claimed purchase is found in the claimed purchases base, 7300; the receipt, the payment and the claimed purchase are reconciled; the conditions are met to pay back the deferred discount to the pending account of the member concerned.

If no payment is selected in the payments base, 7200, a claimed purchase must be found that corresponds to the cash register receipt. The search is therefore focused on identifying a claimed purchase that corresponds to the cash register receipt in the base 7300. The processing is the same as that described above, apart from:
the reconciliation on the member identifier criterion which is not available, if it does not appear in the cash register receipt transmitted by the partner brand name;
the reconciliation on the “receipt number” criterion if this option is used. The processing operations described below are then applied.

If no claimed purchase is found in the base 7300, it is impossible to identify the associated member, and the second discount will not be able to be paid back.

If one or more claimed purchases are selected, for each duly identified member, the holding of a bank card embedding the service is checked:
If the member holds a bank card embedding the service: the second discount will not be able to be paid back, because the member did not use it for the payment; the identity of the member is, however, assigned to the cash register receipt;
If the member does not have any listed bank card embedding the service:
   A single claimed purchase has been found: the second discount will be able to be paid back; the identity of the member is assigned to the cash register receipt;
   Several claimed purchases have been found: each of the duly identified members must then be asked for information on the purchase, in order to finalize the reconciliation: receipt number (a possible error at the time of input, if this option was used at the time of the purchase claim) and amount; it is also possible to envisage requesting a capture of the cash register receipt held by the member.

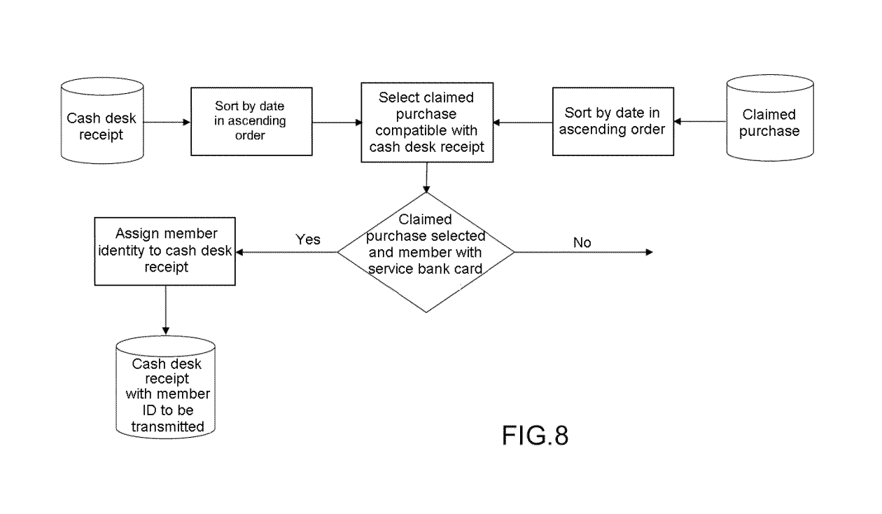

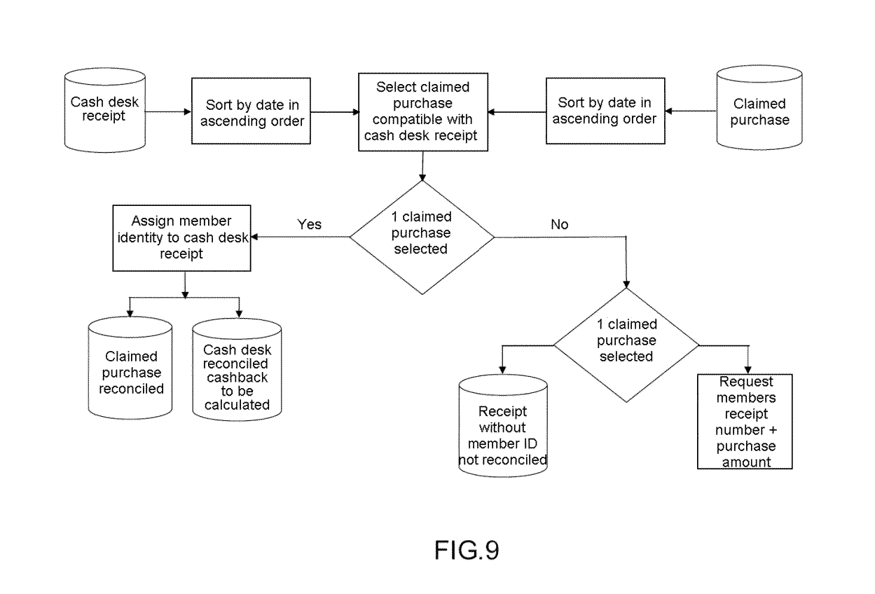

As indicated above, it may be advantageous to assign an identity to the cash register receipt before the processing operations described above. This variant is represented in FIGS. 8 and 9.

For each cash register receipt, a claimed purchase is sought:
The receipts without claimed purchase, or for which the identified member is not a holder of the bank card embedding the service, are not transmitted to the banking partner;
If a single claimed purchase is selected, and the duly identified member has a bank card embedding the service, his or her identity is associated with the cash register receipt;
If several claimed purchases are selected, the identity of each duly identified member, holder of a bank card embedding the service, is associated with the receipt. The reconciliation with the payment will make it possible to correctly identify the member.

Based on the results, the following processing operations are then carried out, consisting in identifying the claimed purchase corresponding to the cash register receipt. The processing operations are identical to those described above, apart for:
the reconciliation on the member identifier criterion which is not available if it does not appear in the cash register receipt transmitted by the partner;
the reconciliation on the “receipt number” criterion if this option is used; this part of the processing operation is useful, if the bank card embedding the service is currently being issued (its handover date will not be known at best until D+1).

Efforts are made to reconcile a cash register receipt of the base 7100 with a claimed purchase of the base 7300. For each cash register receipt, a claimed purchase is sought. The processing operation is identical to that described above, apart from:
the reconciliation on the member identifier criterion which is not available if it is not included in the cash register receipt transmitted by the partner;
the reconciliation on the “receipt number” criterion if this option is used. Based on the results of the preceding step, the following subsequent processing operations are applied.

In the case where no claimed purchase is found, it is impossible to identify the associated member, and the second discount will not be able to be paid back.

In the case where a single claimed purchase has been found, the second discount will be able to be paid back to the member. The identity of the member is assigned to the cash register receipt.

In the case where several claimed purchases have been found, the service provider can then ask each of the duly identified members for information on the purchase, in order to finalize the reconciliation: receipt number (possible error at the time of input, if this option was used at the time of the purchase claim) and amount. Requesting a capture of the cash register receipt held by the member may also be envisaged.

The reconciliations of the transactions made by Internet must also be performed.

The service provider has the cash register receipt and its number (information obtained by means of the service email). It can reconcile this receipt with the information transmitted by the merchant: it is only necessary to check that the purchase is not rejected:
If the payment was made by the card of the service provider, the reimbursement linked to the rejection being made to the card, it is sufficient to await the expiry of the retraction delay;
If the payment was made with another card, the information must come from the merchant; the member is then informed automatically by the service provider.

On completion of all or some of the processing operations described above, it is possible to perform the calculation of the discount level reached by each purchase group. The reconciled receipts are grouped together by purchase group. For each purchase group:
The number of purchasers with at least one validated purchase, if necessary satisfying the fixed minimum eligibility amount, is counted;
Based on the number and, possibly, on the amount reached by the purchase group, the discount level defined for the sale is associated.

It is then possible to perform the calculation of the individual amount of the deferred discount. For each receipt, the amount of the deferred discount is established according to the share of the purchase affected by the promotion.

It is then possible to go on to the step of paying back the deferred discount. This begins with a step of establishing the credit:
In order to return an amount inclusive of taxes to the member, a credit is established for the account of the point of sale of each partner brand name;
The credit is transmitted to the member and to the partner.

The process then goes on to the step of paying back to the card or to the account of the member:
If the member is the owner of a card whose validity date is not expired, the card is credited with the amount of the credit;
If the card is expired or if the member does not yet have a card:
   If the amount is less than the value of the contribution to be paid for the card set by the service provider and the banking partner, the amount to be restored remains on a “pending account”;
   If the amount to be paid back is at least equal to the value of the contribution of the service, the production of the card is launched.

The process followed for the production and handover of the card is described below.

Said process begins with a collection of the necessary information stipulated by the service provider. After having been identified, the member is invited to complete all or part of the following items, other items also being able to be judged necessary or useful by the service provider:
Identity: civility, surname, first name, date of birth
Address, including postcode
Cell phone number
Acceptance of the CGV (general conditions of sale of the card, set by the banking partner).

If a solution of “PayPal”™ type is implemented, the user then enters the number of the bank card on which the final payment would be made. To avoid any rejection, the user must then enter the information necessary to the use of a secure 3D code with his or her bank (email address or cell phone number to which the secure 3D code will be transmitted). In order to check the performance of this step, it may be advantageous to generate a dummy purchase of an amount less than ε1 (which will be immediately recredited).

The process may include a step of billing for the contribution of the service. A service contribution bill (or card billing) is produced, then sent to the member's email address.

The information items collected by the service provider are transmitted to the card manufacturer.

The card of the banking partner of the service provider can be handed over to the member, for example, by one of the following procedures:
Direct handover via a branch of the partner banking establishment;
Postal delivery to the home with acknowledgement of receipt (registered mail).
The date of handover of the card is incorporated in the service.

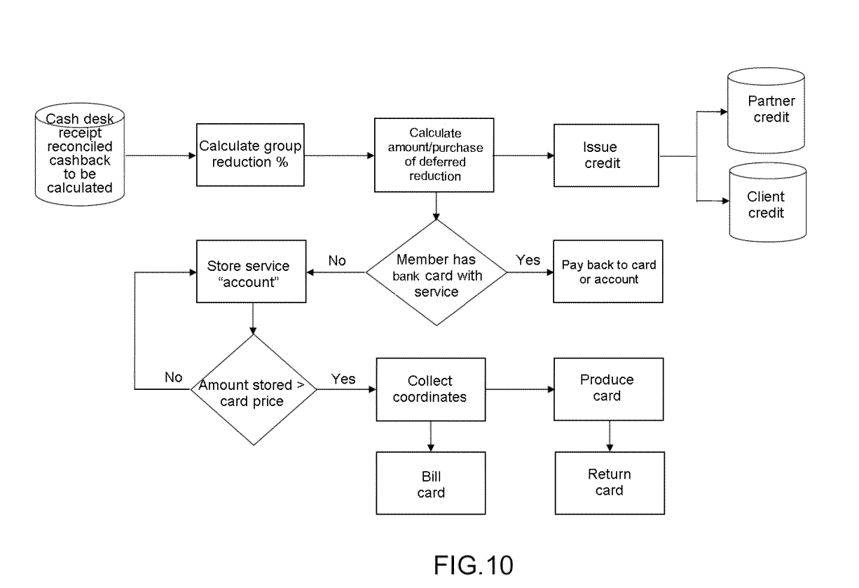

FIG. 10 represents a step of processing the deferred discount according to one embodiment of the system of the invention.

The processing operations represented in FIG. 10 are performed by the service provider in order to calculate the second discount applicable to the purchase group and to each member of the service provider belonging to the purchase group concerned. They have been described above.

FIGS. 11a, 11b and 11c represent a device that makes it possible to assign the identity of a purchaser to a cash register receipt according to one embodiment of the system of the invention.

In one embodiment of the invention, the aim is to ensure an unambiguous correlation between the cash register receipt and the purchase coupon of the VFG concerned.

The merchant of the partner brand name presents the client with the cash register receipt previously inserted into the support supplied by the service. The support takes the following form:
The receipt is slid between two flaps, 1110b and 1120b, which are folded down;
The flap 1110b has a window in which the cash register receipt appears, 1110c;
The unique identifier, 1120c, of the cash register of the point of sale of the partner brand name appears on this flap.

After activation of the application, the member picks up the image of the cash register receipt inserted into the support. To this end, augmented reality is used, which makes it possible to:
frame the shot: the member must have the frame of the support superposed with that of the augmented reality;
check the sharpness of the image: a pictogram present on the support allows the application to check for the absence of blurring by image processing techniques within the scope of a person skilled in the art.

The application validates the quality of the image if:
the frame is within an acceptable slice of approximation;
the required level of sharpness is reached.

The image is then picked up and then transmitted to the service provider which can then use it to perform the reconciliation processing operations described above in association with FIGS. 7 to 10.

A variant of this modality consists in including in the service application a barcode reading module, such as MobileTag™ or RedLaser™, the partner brand name having the possibility of including the date- and time-stamped promotional code in a specific area of the barcode of the cash register receipt.

The modality which fits best into the management system of the partner brand name will be preferred. It is therefore probable that the manager of the VFG service will propose different validation modalities.

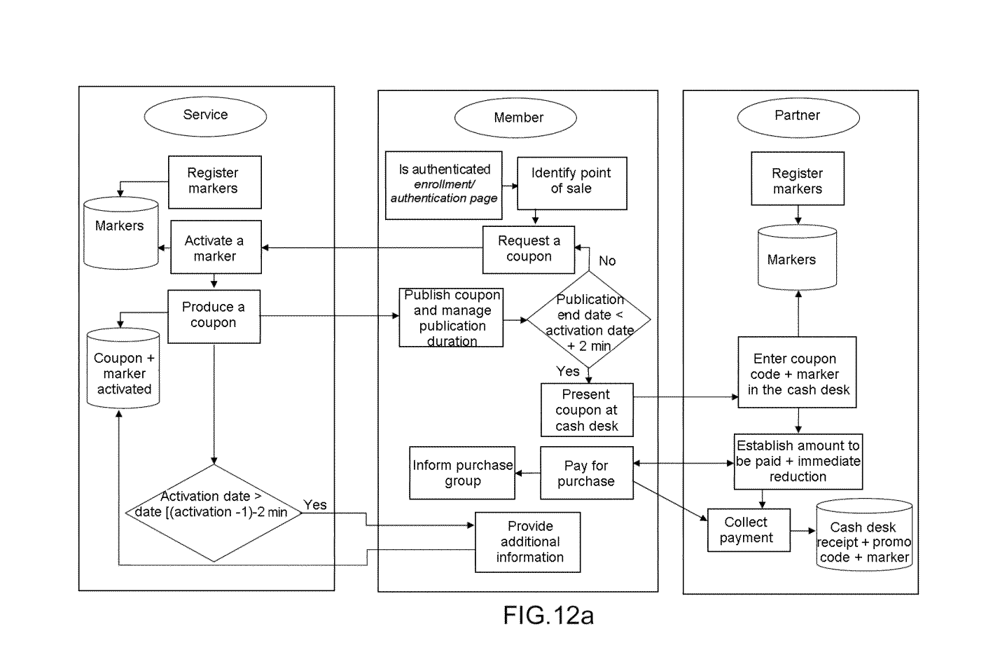

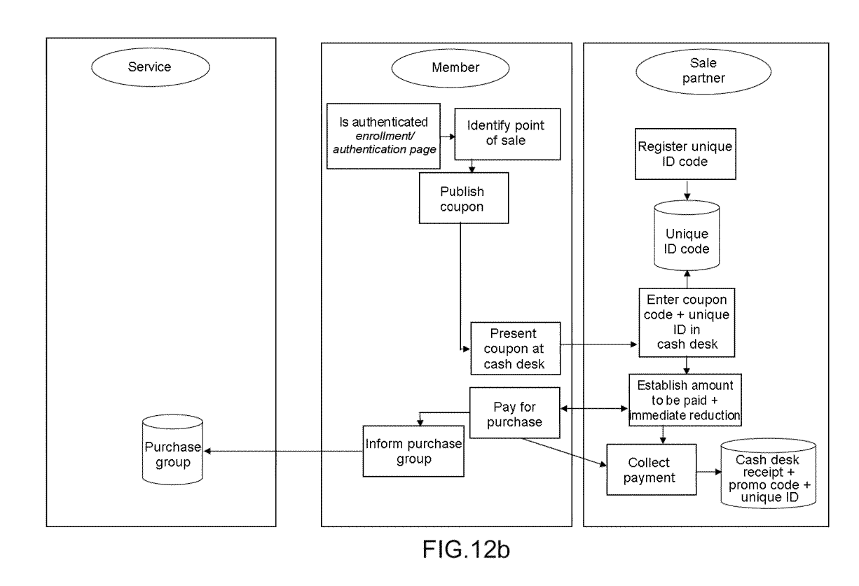

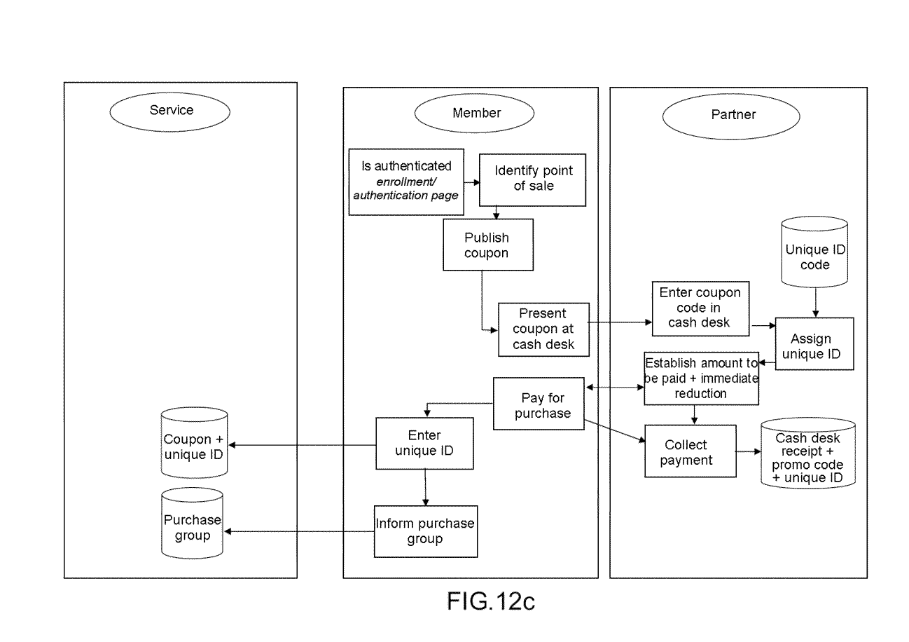

FIGS. 12a, 12b and 12c represent details of the steps of issue of a purchase coupon and of the use of an associated code in the sale step according to several variants of the system of the invention.

According to the variants illustrated by FIGS. 12a, 12b and 12c, specific means are provided to perform the following operations at the point of sale in which a member of a VFG group is present to participate in a promotion:
allowing the member to obtain the immediate reduction;
creating the information to assign the identity of the member to the cash register receipt;
informing the members of the purchase group of the new purchase and therefore of the potential reaching of a new deferred discount level.

The first step of the method according to these variants consists in enabling the member to obtain an immediate cash discount. To this end, the following various substeps are provided in the method of the invention:

This step 1 itself comprises a first substep consisting in proving the eligibility to the immediate discount: the member must first of all prove that he or she can benefit therefrom; this proof is supplied in the form of a reduction coupon published on the smart phone and describing the operation, the amount of the immediate discount and the promotional code; to obtain it, the member must:
activate the application on his or her smart phone;
identify him/herself;
select the VFG from the current VFGs with which he or she has enrolled but for which he or she has not yet claimed purchase (even enroll with the VFG if he or she has not yet done so);
request the promotional code;
the application produces the purchase coupon, notably comprising the promotional code, and the date- and timestamp;
the application then creates the information that allows the identity of the member to be assigned to the cash register receipt.

For this creation, a number of variants are possible depending on the equipment of the cash registers and the software configuration of the management system of the points of sale. One solution is to use unique client identification codes produced by the brand name. These unique codes can be distributed to the clients by the brand name by being introduced into the cash register receipt then transferred to the VFG service at the initiative of the client by capture or reinput (variant 3, FIG. 12c). These unique codes can alternatively be distributed by the VFG service which will have obtained them previously from the brand name. In this case, they will be published in the purchase coupon then transferred to the cash register receipt by capture or input (variant 2, FIG. 12b). Moreover, in as much as not all the brand names have an information system, and notably cash registers, enabling them to manage a large quantity of unique codes, the invention provides a universal alternative solution covering all possible cases. This solution (variant 1, FIG. 12a) consists in producing, in real time (at the time of the request for the purchase coupon, the point of sale having been identified), a triplet comprising:
an alphanumeric marker conforming to the principles of coding of items by the brand name;
the date of issue of the purchase coupon;
the identification of the point of sale.

This triplet constitutes a pseudo-unique code, that is to say one that makes it possible, in subsequent processing, to assign the identity of the client to the cash register receipt after the marker has been transferred from the purchase coupon to the cash register receipt by capture or input.

These three additional variants of the invention are explained in detail hereinbelow.

1) Variant 1 (FIG. 12a):

Include in the cash register receipt a code authenticating the execution of the purchase by the holder of the coupon. In this variant, a pseudo-unique code is assigned at the time of the issue of a purchase coupon in the context of a VFG. This pseudo-unique code consists of the triplet made up as explained above (marker+date of issue+identification of the point of sale).

Provided that the number of markers is sufficient (some tens or hundreds for some hundreds of thousands of potential participants in a VFG or in a sales program), the member is then identified by a code for which the probability of being unique for a short period of time is sufficiently high to guarantee an industrial reliability. The code appears in alphanumeric or barcode form, in the purchase coupon published on the member's smart phone. For each purchase coupon request from a member on the smart phone application, the published code is the one for which the last publication date is the oldest. To increase the probability that it is unique (or to reduce the size of the series of specific item codes), the management of the publication can be performed by point of sale. The identifying of the place where the member is located at the point of sale then relies on
the geolocation function of the smart phone;
or, if the accuracy of the geolocation system is insufficient, on the smart phone picking up a signal (RFID, etc.) or an image (barcode, 2D code, etc.) identifying the point of sale (even each cash register within the point of sale), or else selection of the point of sale from a list of points of sale displayed in the smart phone application.

Since the time it takes to pass through a cash register is of the order of a few minutes (for example 1 to 3 min), the probability that one and the same code might be published more than once within this time interval of a few minutes at one and the same cash register is close to zero. To operate safely, it is, however, necessary for the publication time to also be a few minutes: beyond which it is thus possible to require the member to request a new code.

In this variant, it is necessary for the marker code to have a structure compatible with the information system of the partner brand name. This result can be achieved in two ways:
the code has a format equivalent to that of the item codes of the partner brand name within a range that is not used, said codes being matched where appropriate with a zero sale price;
this code can also be obtained from a series of promotional codes (each allowing the cash register system to calculate the amount of the immediate discount, which is not the case with the item codes).

2/Variant 2 (FIG. 12b):

the VFG service assigns a unique identifier to the members of a VFG.

This assignment preferably takes place at the time of enrollment with each VFG.

A case of application of this variant can be imposed by the partner brand names for the members of their loyalty programs provided with specific cards. In this case, the member of the VFG service who is enrolled with a given VFG is:
either asked for his or her loyalty card number if he or she is a member of the brand name's program
or assigned his or her unique number in an unused range of the coding of the partner brand name's loyalty cards.

The identification of the member at the time of a purchase in the context of this VFG is done according to the procedures of said loyalty program in parallel with the presentation of the coupon.

If the member of the VFG service who participates in a VFG is not a participant in a loyalty program of the brand name, the management of unique codes generated by the VFG service will generally be more costly and therefore less advantageous than variant 1. In practice, in this variant 2, the cash register system of the brand name must have the capacity to store a large number of unique identifier codes or to access a constructed base containing such codes.

To secure the authentication, the VFG service and the partner brand name must have exchanged the unique codes before the start of the sale.

3/Variant 3 (FIG. 12c):

Upload to the VFG service information obtained from the cash register system via the smart phone's application.

The information may either be a unique code, for example the receipt number or a unique code managed by the information system of the partner brand name, or information which need not be unique but which is characteristic of the transaction, such as the receipt amount. To transfer the information to the smart phone application:
either the cash register system transmits an audio or visual signal (2D code, barcode, etc.) which can be picked up by the smart phone;
or the member enters the information; if the option of the amount is chosen, it is necessary to check the unique nature of this information, in order for it to be able to truly allow the member to be identified; it is therefore necessary to systematically compare the amount entered with the amount entered previously; if they match, the member is then prompted to enter another identifier (for example the receipt number).

The first substep then concludes with the display of the promotional code and of the possible code identifying the member in the application to be presented to the vendor or at the cash register.

During a second substep of this step 1, the promotional code, and the code identifying the member if necessary, are introduced into the cash register system; this substep can be performed by means of:
the input of the promotional code, and of the code identifying the member if necessary, into the cash register system by an operator (the vendor or the purchaser);
the reading of visuals present on the purchase coupon (for example barcodes) by means of a suitable reader linked to the cash register;
the transmission of a signal by the smart phone and its reception by the cash register system (NFC chip, RFID, Bluetooth, Wifi, etc.);
or possibly the card participating in the loyalty program.

During a third substep of this step 1, the amount of the immediate discount is calculated; the cash register system applies the immediate discount according to the terms of the VFG; the promotional code triggers the calculation of the discount (it will first have been parameterized by the partner in the cash register system thereof).

During a second step, the members of the purchaser's purchase group are informed of the purchase and therefore of the potential to reach an additional discount level.

Once the purchase coupon is published on the smart phone, the member is prompted to inform his or her group of the purchase and therefore of the potential reaching of a new level. This step amounts to claiming the purchase, as in the other variants of the invention described above in relation to FIGS. 4 and 5, although in the case of the variants of FIG. 12, the status of this step is purely informative. It will have to be validated during reconciliation.

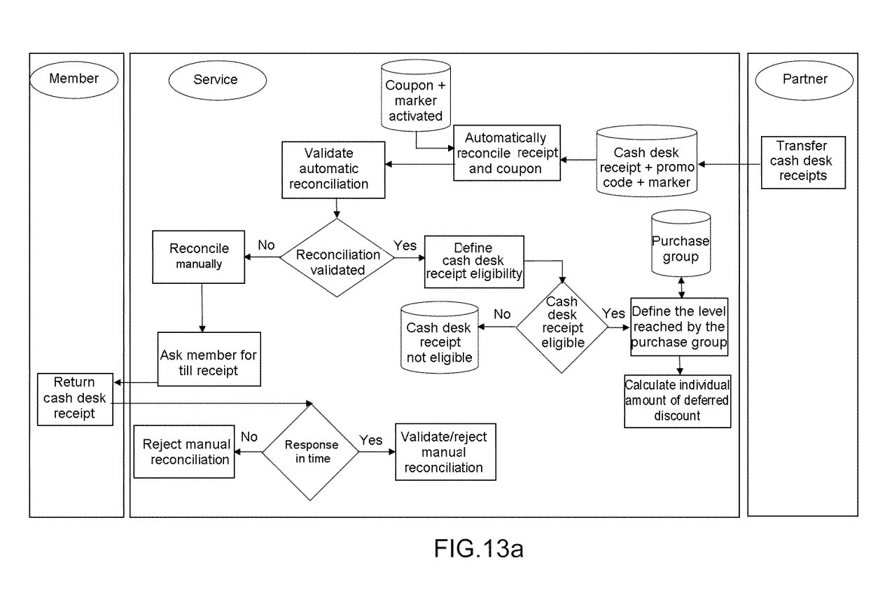

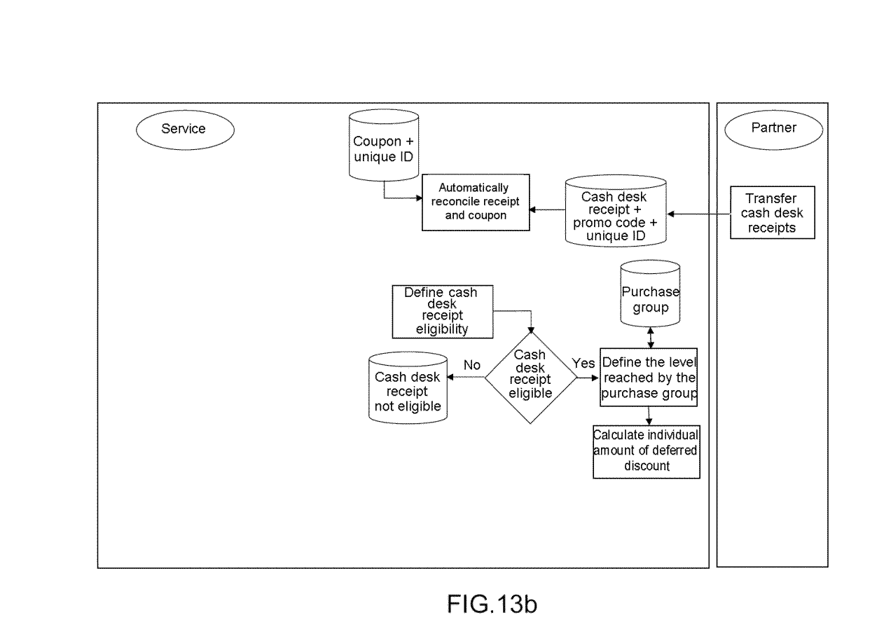

FIGS. 13a and 13b represent how a step of reconciliation of cash register receipts and of the coupons proceeds in the variants of the system of the invention illustrated in FIGS. 12a, 12b and 12c.

The main difference between the variants described in relation to FIGS. 12a, 12b and 12c and those of FIGS. 4 and 5 is that, in the latter, the reconciliation assumes, for the VFG service to be able to guarantee the reliability of the deferred discount calculations: i) a purchase claim by the member; ii) a principally payment-based reconciliation. In the variants of FIGS. 12a, 12b and 12c, the exchange of a unique code (variants 2 and 3 above) or pseudo-unique code (marker of variant 1) makes it possible to avoid both the purchase claim (except to inform the other members of the purchase group that a discount level has been crossed) and the use of the payment file. The calculation of the amount of the deferred discount then comprises four steps:
Step 1: the assignment to each purchase listed as incoming in the context of the sale considered, of a purchaser to whom an identity can be assigned;
Step 2: the validation of this assignment;
Step 3: the calculation of the deferred discount as a percentage;
Step 4: the calculation of the deferred discount as an amount.

Only the step 1 is described in detail below.

After the sale (either each evening, or after closure):

the partner brand name transmits to the VFG service all the cash register receipts relating to the sale (the receipts include a promotional code, a unique identifier code or a marker);

the cash register receipts and the issued purchase coupons are sorted by the computer system of the VFG service by point of sale and cash register, according to the date criterion in ascending order.

The reconciliation modalities are then different depending on the type of code used at the cash register:
Variant 1 (use of markers): there is first an automatic reconciliation between cash register receipt and purchase coupon.
Variants 2 & 3 (use of unique codes assigned either by the VFG service or by the partner brand name): the identity of the member is assigned to the receipt through the unique code which appears on the cash register receipt.

1/Variant 1 (FIG. 13a): Cash Register Receipt and Coupon Reconciliation

For each cash register receipt, the information allowing for the reconciliation is extracted: promotion code, marker, date (year, month, day, hour, second), the point of sale and cash register number (if this information is available).

The issued purchase coupon corresponding to the cash register receipt is then sought. The search criteria are: marker, date of activation of the marker, point of sale and, optionally if this information is available, amount of the purchase.

Then, out of the unreconciled purchase coupons, the following purchase coupons are sought:
Those issued for the point of sale appearing on the receipt,
Those which have the same marker,
Those for which the (activation date) is prior to (the date of the receipt), but greater than [(the date of the receipt)−(display delay)].
   The results are then analyzed:
If a single purchase coupon is found (case 1), the receipt and the purchase coupon are reconciled:
   the status of the reconciliation changes to positive reconciliation. The mode (automatic) and the date are stored. The receipt and the coupon take the “reconciled” status.
If no purchase coupon is found (case 2):
   the status of the reconciliation changes to negative reconciliation. The mode (automatic) and the date are stored. The receipt takes the “unreconciled” status.
If several purchase coupons are found (case 3), an operator must approve the reconciliation, because there has very probably been a malfunction. To simplify his or her task, the selected purchase coupons are searched through to find those for which the amount is equal to that of the receipt.
   If a single purchase coupon is thus found (case 3.1), this purchase coupon and the receipt are reconciled:
      the status of the reconciliation changes to “positive reconciliation to be approved”. The mode (automatic) and the date are stored. The receipt and the purchase coupon take the “reconciled” status.
   If no purchase coupon is found (case 3.2), the status of the reconciliation changes to “negative reconciliation amount not found”. The mode (automatic) and the date are stored.
      The purchase coupon to be selected is probably the one for which the activation of the marker is the oldest, but it is preferable to ask the member for his or her cash register receipt and by receipt number, date, place, amount and copy of the receipt.
      The receipt takes the “unreconciled” status.
   If several purchase coupons are found (case 3.3), the status of the reconciliation changes to “negative reconciliation several coupons”. The mode (automatic) and the date are stored. The operator will have to ask each member for his or her cash register receipt and by receipt number, date, place, amount and copy of the receipt. The receipt takes the “unreconciled” status.

2/Variant 2 (FIG. 13b): Reconciling the unique code of the VFG service appearing on the purchase coupon with the code appearing on the cash register receipt of the partner brand name:

The member is identified by a unique code assigned by the information system of the VFG service and accepted by the information system of the partner brand name. The code appearing on the purchase coupon has been transferred at the cash register to the cash register receipt.

For each cash register receipt, the information allowing for the reconciliation is extracted: promotion code, unique code, date (year, month, day, hour, second), point of sale and cash register number (if this information is available).

Since the unique code was assigned to the member at the time of his or her enrollment in the sale, the member is duly identified on the basis of this unique identifier appearing on the receipt, which also appears on the purchase coupon. The next step is then directly the calculation of the deferred discount level reached by his or her purchase group.

3/Variant 3 (FIG. 13b): Reconciling the unique code appearing on the cash register receipt of the partner brand name with the code appearing on the coupon:

The member is identified by a unique code obtained from the information system of the partner brand name which has been registered by the VFG service.

For each cash register receipt, the information allowing for the reconciliation is extracted: promotion code, unique code, date (year, month, day, hour, second), point of sale and cash register number (if this information is available).

The identity of the member is associated with the unique code based on the information input by the member or transferred to his or her smart phone at the end of his or her purchase at the point of sale. The next step is then directly the calculation of the deferred discount level reached by his or her purchase group.

In the case where a transaction is performed by Internet, it is possible, for example, to assign the member a unique code that he or she must input in his or her order form on the partner merchant site, or else a code is communicated to him or her via tracking links requiring the member to do so from the site of the service to benefit from the operation.

The different variants described above, notably the use of a marker or of a unique code specific to the partner brand name or to the VFG service can in reality be implemented in parallel in one and the same system to implement the invention. Such a combination allows in particular a manager service to process, for one and the same brand name, members joining the loyalty program of the brand name and other members not joining said program.

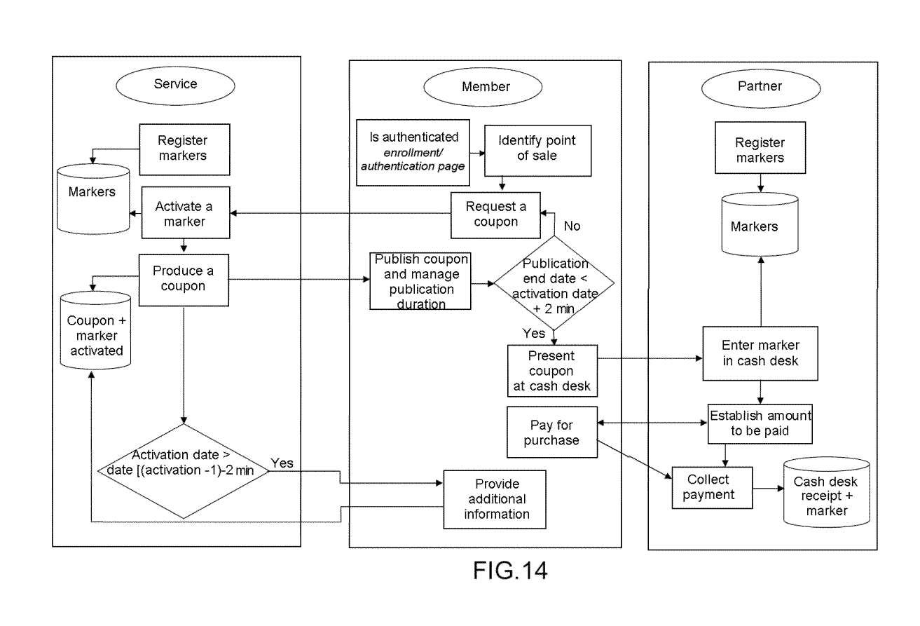

FIG. 14 represents details of steps of issue of a purchase coupon and of the use of an associated pseudo-unique or unique code in the sale step according to a number of variants of the invention.

Furthermore, according to certain aspects of the invention, the method of assigning an identity of the client to a cash register receipt for certain promotional operations performed by marketing brand names can be used outside of VFGs.

As represented in FIG. 14, the steps of enrollment, of issue of a pseudo-unique or unique code inserted into a purchase coupon which is requested by an enrolled member and received on the smart phone of the member, can be implemented independently of the steps consisting in calculating the amount of a second discount which would be a function of the number or of the amount of sales performed in a group. They can be used as a base for validating other marketing operations reserved for a targeted population of purchasers.

Notably, the use of a marker, constituting a pseudo-unique code or a unique code transferred by a brand name or a manager service to a purchase coupon transmitted to a smart phone, enables a brand name to totally dematerialize its loyalty programs and to make savings on the production and the distribution of the cards usually associated with this type of program. The purchase coupon can be specific to a sale or identical from one sale to another. The capture at the cash register of the marker from the purchase coupon presented by the member is performed according to the same modalities as those described above for the VFGs. It can be used only to assign a first discount or credit the account of the member with loyalty points whose conditions of use will be able to be variable from one brand name to another, with flexibility of assignment and of management that is not afforded by the assignment of points to a card carried by the member.

The method of assigning an identity linked to a pseudo-unique or unique code transmitted at the request of a member enrolled in a service to his or her smart phone also makes it possible to create a database of the purchases of said member which can then be made available to him or her or, with his or her agreement, to third parties, to enable the member to have electronic information on his or her purchases and the third parties to have detailed marketing data, within the limits of compliance with the rules imposed by legislators.

The examples described above are given to illustrate embodiments of the invention. They in no way limit the scope of the invention which is defined by the claims which follow.

1. A computerized method for managing grouped promotional sales comprising at least one step of registering a purchaser user with at least one grouped promotional sale by connection to a service provider using a user terminal, a step of determining a first discount applicable to said at least one promotional sale, a step of purchase by said purchaser user at a point of sale at the price resulting from the application of said first discount, said method further comprising a step of validation by said service provider of the purchases made by the purchaser users that are members of the group of said grouped promotional sale at the date of closure of said grouped promotional sale and a step of calculating a second discount that is a function of the amount of the validated purchases.

2. The computerized method of claim 1, wherein the registration step comprises a substep of enrollment to said service during which said purchaser user supplies information relating to his or her identification enabling said user to download to a cell phone at least one computer application from the service provider that can be executed on said cell phone.

3. The computerized method of claim 2, wherein the registration step comprises a substep of enrollment to said service during which said purchaser user subscribes to a bank card issued by a banking partner of the service provider, said bank card being associated to a debit/credit account for a means of payment for promotional sales of the service provider.

4. The computerized method of claim 1, wherein the registration step comprises a substep of enrollment to a purchase group either by creation of said purchase group or by incorporation in an existing purchase group.

5. The computerized method of claim 2, wherein the purchase step is performed in a physical point of sale and comprises at least one first substep of downloading to said at least one cell phone a purchase coupon issued by the service provider for a promotional sale and comprising a code characterizing said promotional sale, a second substep of paying for said purchase at a cash register of said point of sale, said payment taking into account the first discount, a third substep of capturing said code characterizing said promotional sale in the computer system of the point of sale.

6. The computerized method of claim 5, wherein said cell phone has image capture functions and in that said substep of capturing said code is performed by acquisition by said at least one cell phone of at least one image characterizing said cash register of said point of sale.

7. The computerized method of claim 5, wherein the purchase step also comprises a substep of capture by said at least one cell phone of information characterizing the cash register receipt issued by the cash register of said point of sale for said purchase.

8. The computerized method of claim 5, wherein the validation step comprises a substep of claiming from the service provider for a purchase made in the context of a promotional sale, said substep of claiming consisting in supplying the service provider with the information captured by said at least one cell phone which characterizes at least one item belonging to the purchase group comprising said cash register where said purchase was paid for and the cash register receipt for said purchase.

9. The computerized method of claim 8, wherein a claimed purchase is validated if, and only if, a first predefined subset of information relating to the promotion code of the reduction coupon and a second predefined subset of the information captured by said at least one cell phone which characterizes at least one item belonging to the group comprising said cash register where said purchase was paid for and the cash register receipt for said purchase satisfy a third subset of predefined criteria.

10. The computerized method of claim 5, wherein the validation step comprises a substep of reconciliation by the service provider of a database containing information deriving from the cash register receipts relating to said promotional sale supplied by the points of sale having participated in said sale with information supplied by the banking partner relating to the payments for the purchases made in said points of sale.

11. The computerized method of claim 10, wherein said reconciliation comprises a consistency check on the time windows of the purchase and of the payment.

12. The computerized method of claim 10, wherein the substep of reconciliation of the cash register receipts and of the payments is preceded by a substep of assignment of the identities of the purchaser users to the cash register receipts.

13. The computerized method of claim 10, wherein the validation step also comprises a substep of reconciliation by the service provider, for a given payment and at least one reconciled cash register receipt, with a database of the purchase claims relating to said promotional sale.

14. The computerized method of claim 10, wherein, on leaving the validation step, the service provider stops the list of the validated purchases of the current promotional sale, said list comprising the purchases for which the cash register receipts, the payments and the purchase claims have been reconciled.

15. The computerized of claim 14, wherein only the payments made with a bank card issued by a banking partner of the service provider are eligible for the reconciliation, said bank card being associated with a debit/credit account for a means of payment for promotional sales of the service provider.

16. The computerized method of claim 5, wherein the coupon downloaded to said at least one cell phone also comprises a marker assigned by the service provider.

17. The computerized method of claim 16, wherein said maker is transferred to the cash register receipt.

18. The computerized method of claim 17, wherein the validation step comprises a substep of reconciliation of the cash register receipts and of the purchase coupons of a promotional sale, said reconciliation substep validating the purchases for which a single cash register receipt and a single coupon comprise an identical marker for a given point of sale within a determined time window.

19. The computerized method of claim 5, wherein the purchase coupon downloaded to said at least one cell phone also comprises a unique identifier of the purchaser user assigned by the service provider, said unique identifier having been communicated first to the vendor of the good that is the subject of the promotional sale.

20. The computerized method of claim 19, wherein said unique identifier of the purchaser user is transferred to the cash register receipt.

21. The computerized method of claim 5, wherein the cash register receipt comprises a unique identifier of the purchaser user assigned by the vendor of the good that is the subject of the promotional sale, said unique identifier having been communicated previously to the service provider.

22. The computerized method of claim 21, wherein said unique identifier of the purchaser user is transferred to the cell phone of the purchaser user.

23. The computerized method of claim 20, wherein the validation step comprises a substep of reconciliation of the cash register receipts and of the purchase coupons of a sale, said reconciliation substep validating the purchases for which a unique cash register receipt and purchase coupon comprise an identical unique identifier.

24. The computerized method of claim 18, wherein, on closure of the promotional sale, the amount of a second reduction is calculated and credited to the account of the purchaser user.

25. A computerized method for managing the clients of a distribution network comprising at least one step of registration of said clients and at least one step of purchase from a store of said network, said method being wherein said registration step comprises at least one substep of enrollment with said distribution network during which said client supplies information relating to his or her identification enabling him or her to download, to a cell phone, at least one computer application that can be executed on said cell phone and in that the purchase step comprises at least one first substep of downloading a purchase coupon issued by the network to said at least one cell phone, said purchase coupon comprising an identifier of said client for this purchase, and a second substep of transferring said identifier between the cell phone of said client and a cash register receipt of a point of sale of said network.

26. The computerized method of claim 25, wherein said identifier of the client is compatible with the principles of coding of the items of said network and in that the date of the purchase coupon and an identification of the point of sale are associated with said identifier of the client, said triplet constituting a pseudo-unique code.

27. The computerized method of claim 25, wherein said identifier of the client is a unique code distributed by a service provider, said unique code having been communicated first to said service provider by the network.

28. The computerized method of claim 25, wherein said identifier of the client is a unique code distributed by the network.

29. The computerized method of claim 26, wherein it also comprises a step of validation of the purchase made by said client in said point of sale, said validation step comprising a substep of reconciliation of the cash register receipts and of the purchase coupons of a sale, said reconciliation substep validating the purchases for which a unique cash register receipt and purchase coupon comprise either an identical marker for a given point of sale within a determined range of dates, or a unique code.

30. A computer system for managing grouped promotional sales comprising at least one module for registering a purchaser user with at least one grouped promotional sale by connection to a service provider using a user terminal, a module for determining a first discount applicable to said at least one promotional sale, a module for payment for a purchase by said purchaser user at a point of sale at the price resulting from the application of said first discount, said system being wherein said computer system further comprising a module for validation, by said service provider, of the purchases made by the purchaser users that are members of the group of said grouped promotional sale at the date of closure of said grouped promotional sale and a module for calculating a second discount that is a function of the amount of the validated purchases.

31. The computer system of claim 30, further comprising at least one cell phone having image reproduction and capture functionalities and functionalities for downloading at least one computer application from the service provider and executing said application.

32. The computer system of claim 31, further comprising a bank card issued by a banking partner of the service provider, said bank card being associated with a debit/credit account for means of payment for promotional sales of the service provider.
